(19) United States
(12) Patent Application Publication
(10) Pub. No.: US 2002/0180781 A1
(43) Pub. Date: Dec. 5, 2002

(54) Web-based content on an electronic program guide

(76) Inventors: Thomas Edward Cezeaux, Woodinville, WA (US); Derek K. Vogel, Woodinville, WA (US)

Correspondence Address: PERKINS COIE LLP, PATENT-SEA, P.O. BOX 1247, SEATTLE, WA, 98111-1247, US

(21) Appl. No.: 10/158,576

(22) Filed: May 29, 2002

Related U.S. Application Data
(60) Provisional application No. 60/295,064, filed on May 31, 2001.

(51) Int. Cl. G09G 5/00

(52) U.S. Cl. 345/738

(57) ABSTRACT

Methods and systems for improving a user's experience with a set-top box. A system for allowing a user to subscribe to a subscription service when the user selects to view the content of the subscription service is provided. A system for replication of configuration information for set-top boxes is provided. A system for monitoring and blocking content being viewed by another is provided. A system that allows nontelevision programming content to be represented as a channel of an electronic program guide is provided.

### CROSS-REFERENCE TO RELATED APPLICATIONS

This application claims the benefit of U.S. Provisional Application No. 60/295,064 filed May 31, 2001 entitled “SET TOP BOX TECHNIQUES” and claims the benefit of U.S. Pat. application Ser. No. 10/039,292 filed Jan. 3, 2002 entitled “INTERACTIVE TELEVISION SYSTEM” which are hereby incorporated by reference in their entirety.

### BACKGROUND

The described technology relates generally to set-top boxes and various techniques for improving a user's experience when interacting with a set-top box.

Set-top boxes have been a widespread mechanism through which advanced programming features have been provided to television viewers or users. A set-top box connects a content feed (e.g., cable or satellite) to a television. A set-top box can control what content from the content feed is directed to the television. A set-top box may also interact with a content provider system to coordinate the providing of the custom content, such as on-demand programming.

A set-top box may also provide an electronic program guide to allow the users to view programming information for available television channels and to select which television channel to watch. Set-top boxes may access programming information (e.g., channel, title, and start time) provided through the content feed (e.g., on a designated channel) and generate a display of the information referred to as an electronic program guide. Electronic program guides are generally displayed in a grid format with start time information displayed horizontally and channel information displayed vertically. Each cell of the grid may contain the title of the content provided on that channel at that time. Set-top boxes typically allow users to use a remote control to scroll through the electronic program guide and select a channel to be watched.

Set-top boxes may also provide an interface through which users can configure their viewing experience. For example, a parent may configure a set-top box to filter out any content that the parent might find objectionable. The user may also configure the set-top box to display electronic program guide information in various ways. For example, rather than displaying program guide information in channel order, a user may select to display the program guide information in genre order (e.g., news, soap operas, science fiction movies, and cooking).

Although set-top boxes help enhance the viewing experience, some capabilities provided by current set-top boxes are not particularly user-friendly or do not provide all the capabilities that users would like. For example, if a household has multiple set-top boxes, then a user would need to individually configure each set-top box, even though the user may want the same configuration at each set-top box. In addition, the set-top boxes cannot provide a user-friendly way for a viewer to subscribe to new services (e.g., HBO). As another example, the filtering mechanism of set-top boxes may not allow a parent sufficient control over the content viewed by their children. Finally, set-top boxes do not provide an integrated interface between channel content and Internet-based content.

### BRIEF DESCRIPTION OF THE DRAWINGS

FIG. 1 is a block diagram illustrating components of an interactive programming system in one embodiment.

FIG. 2 illustrates an electronic program guide listing subscription services in one embodiment.

FIG. 3 is a diagram illustrating a display that allows a user to subscribe to a service in one embodiment.

FIG. 4 is a flow diagram illustrating the processing of a request to subscribe to a subscription service in one embodiment.

FIG. 5 is a block diagram illustrating various configurations of set-top boxes and administrative servers for replication of configuration information in one embodiment.

FIG. 6 is a flow diagram illustrating the updating of configuration information when the set-top boxes are connected via a local connection in one embodiment.

FIG. 7 is a flow diagram illustrating the processing of a set-top box that receives updated configuration information via a local connection in one embodiment.

FIG. 8 is a flow diagram illustrating the processing of a set-top box that receives updated configuration information from a user and replicates it via an administrative server in one embodiment.

FIG. 9 is a flow diagram illustrating the processing of an administrative server component that replicates updated configuration information in one embodiment.

FIG. 10 is a flow diagram illustrating the processing of a set-top box that receives updated configuration information from the administrative server in one embodiment.

FIG. 11 is a flow diagram illustrating the processing of a set-top box that receives updated configuration information from a user and sends it to an administrative server for storage in one embodiment.

FIG. 12 is a flow diagram illustrating the processing of the administrative server that receives the updated configuration information and stores it locally in one embodiment.

FIG. 13 is a flow diagram illustrating the processing of a miscellaneous component of a set-top box that retrieves configuration information from an administrative server on as-needed basis in one embodiment.

FIG. 14 is a flow diagram illustrating the processing of the administrative server in response to a request for configuration information in one embodiment.

FIG. 15 is a block diagram illustrating the monitoring by a parent of content being viewed by a child in one embodiment.

FIG. 16 is a block diagram illustrating the user interface for monitoring and blocking of content in one embodiment.

FIG. 17 is a flow diagram illustrating the processing of monitoring the content of a child's television in one embodiment.

FIG. 18 is a block diagram illustrating the display of an electronic program guide that displays Internet-based content as a channel in one embodiment.

FIG. 19 is a block diagram illustrating the display of content associated with a nontelevision programming channel in one embodiment.

### DETAILED DESCRIPTION

A method and system for subscribing to subscription services provided through a set-top box is provided. In one embodiment, the service selection system displays an electronic program guide that lists both subscription services and nonsubscription services. Each service may be represented as a separate channel on an electronic program guide. When a user selects a nonsubscription service, the system enables the transmitting of content associated with that nonsubscription service. When a user selects a subscription service, the system determines whether the user is currently subscribed to the selected subscription service. If the user is currently subscribed to the selected subscription service, the system enables the transmitting of content associated with that subscription service to the set-top box for display on the television. If the user is, however, not currently subscribed to the selected subscription service, the system displays a subscription form for the subscription service. The form allows the user to subscribe to the selected subscription service. The form may also request that the user enter authentication information. When the user is authenticated as appropriate, the system enables the transmitting of the content for the subscription service to the set-top box for display on the television. The system also subscribes the user to the subscription service so that when the user subsequently selects the subscription service, the content of the subscription service will automatically be transmitted to the set-top box for display on the television. In this way, users can subscribe to subscription services through a set-top box at the time they want to view the content of the subscription service.

A method and system is also provided for replicating configuration data for set-top boxes. In one embodiment, the system provides a mapping of set-top boxes that are to share common configuration information. For example, all the set-top boxes in one household may share common configuration data. The system then receives from the user at one of the mapped set-top boxes updated configuration information. The configuration information may include filtering parameters, user interface configuration, and so on. The system then provides the received, updated configuration information to the other mapped, set-top boxes. Upon receiving the updated configuration information, the other set-top boxes update their configuration information. The configuration information can be provided to the other set-top boxes in various ways. In one embodiment, the set-top boxes may be interconnected via a local area network. In such an embodiment, the set-top box through which the user updated the configuration information may automatically send the updated configuration information via the local area network directly to the other set-top boxes. In an alternate embodiment, the set-top box through which the user updated the configuration information may send the updated configuration information to a remote server that then automatically sends the updated configuration information to the other set-top boxes that share common configuration information. Alternatively, each set-top box may maintain no local copy of the configuration information, but rather retrieve the configuration information on an as-needed basis from the remote server. In such a case, the set-top box through which the user updated the configuration information sends the updated configuration information to the remote server for retrieval by the other set-top boxes on an as-needed basis. In this way, a user can update configuration information at one set-top box and have the updated configuration information automatically replicated at other set-top boxes, thus avoiding the difficulties of configuring each set-top box individually.

A method and system for monitoring, via a monitoring television, content being transmitted to a viewing (or monitored) television is provided. In one embodiment, the system receives from a user an indication to display on the monitoring television content being transmitted to the viewing television. For example, a parent may want to monitor through their television the content being viewed by their child on the child's television. The system may require authentication information from the user before monitoring can begin. Alternatively, certain set-top boxes and their connected televisions may be designated as authorized to monitor the content of other televisions for any user. In such a case, the user would not have to enter authentication information. Assuming the user is authenticated and authorized to monitor the content being transmitted, the system enables the content being transmitted to the viewing television to also be transmitted to the monitoring television. The system may also allow the user to block the transmission of the content that is currently being transmitted to the viewing television. For example, a parent, upon seeing the content that their child is currently viewing, may want to prevent the child from viewing that content. The system allows the parent, from their television, to both view the same content that the child is viewing and to block that content from being transmitted to their child's television. In this way, a user has “real-time” monitoring and filtering control over content being viewed by another.

A method and system for presenting television programming information and nontelevision programming information on a common electronic program guide is provided. The television programming information may include conventional programming information, such as channel, time, and title. The nontelevision programming information may include Internet-based information and on-demand programming information. The Internet-based information may include information derived from various web pages that are accessible via the Internet. For example, the Internet-based information may include stock quote information, weather information, traffic information, and so on. The on-demand programming information may include movies that may be purchased on demand. The system displays an electronic program guide that includes a row for each channel of the provided television programming information and at least one row for the nontelevision programming information. When a user selects a channel corresponding to Internet-based information, that information is retrieved via the Internet and displayed. The system may also prompt the user to subscribe to the channel providing the Internet-based information as appropriate. When a user selects a channel corresponding to on-demand programming information, the system prompts the user to subscribe to the on-demand programming and then enables the transmitting of the content for the on-demand programming. In this way, the electronic program guide provides a uniform user interface for accessing content from various sources.

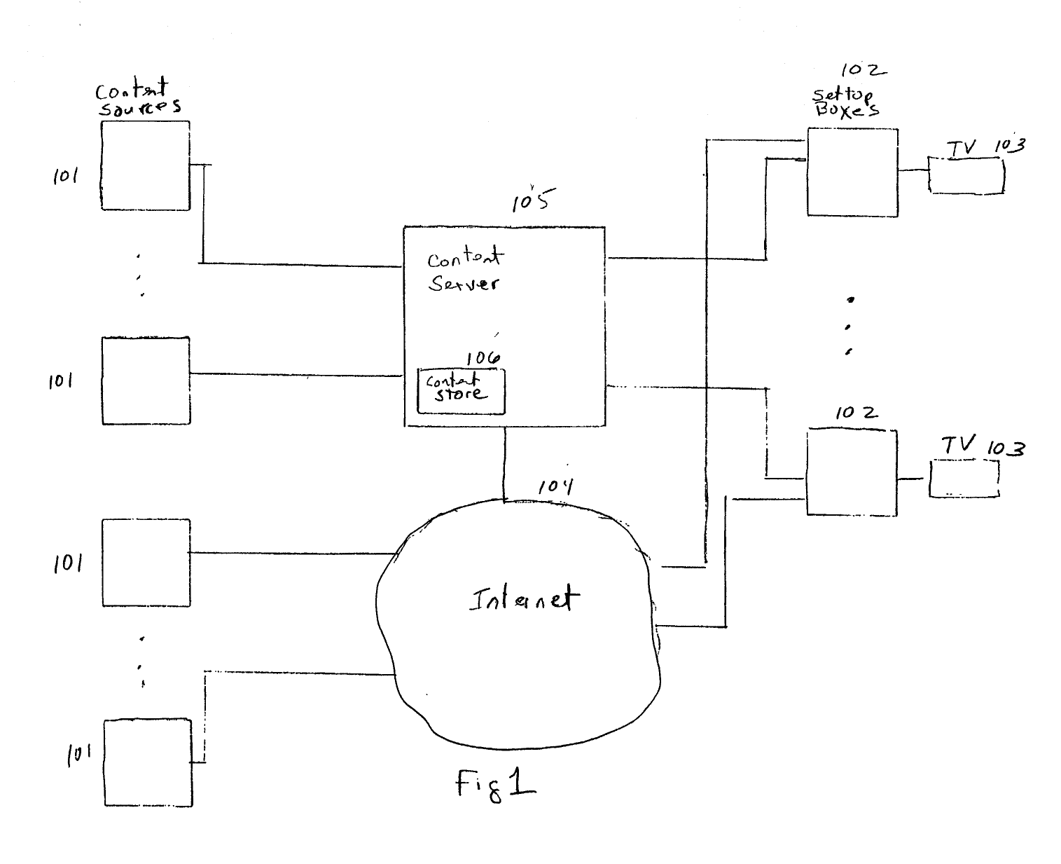

FIG. 1 is a block diagram illustrating components of an interactive programming system in one embodiment. The interactive system comprises components that execute on content server 105 and set-top boxes 102. The content server receives content from various content feeds (or sources) 101. The content feeds may include pay-per-view movies transmitted via satellite, television programming transmitted via cable, and so on. The content server routes content selected by the subscriber or user to the appropriate set-top box. The set-top boxes control the display of the content on the televisions 103. The set-top boxes are responsible for interacting with the user to provide an electronic program guide. The set-top boxes may also provide access to various content sources via the Internet 104. The Internet-based content may alternatively be provided only through the content server. The content server may include the content store 106 that contains videos that can be supplied to the set-top boxes on demand. Although not shown, the content server may contain databases of subscriber information, a billing component, an authentication component, and so on. In some embodiments, this may be a separate administrative server that manages this administrative information. In such a case, the set-top boxes may be connected to both servers, and the servers may be connected to each other. Also not shown, the configuration information for the set-top boxes may be stored at the set-top boxes themselves or at the content server 105.

The servers and set-top boxes may be computers that include a central processing unit, memory, input devices (e.g., keyboard and pointing devices, television and remote controls), output devices (e.g., display devices), and storage devices (e.g., disk drives). The memory and storage devices are computer-readable media that contain instructions that implement the system. In addition, the messages, data structures, and programming instructions of the system may be stored or transmitted via a data transmission medium, such as a signal or a communications link. In addition, the functionality of a set-top box may be built into a television.

Subscriber Self-Provisioning

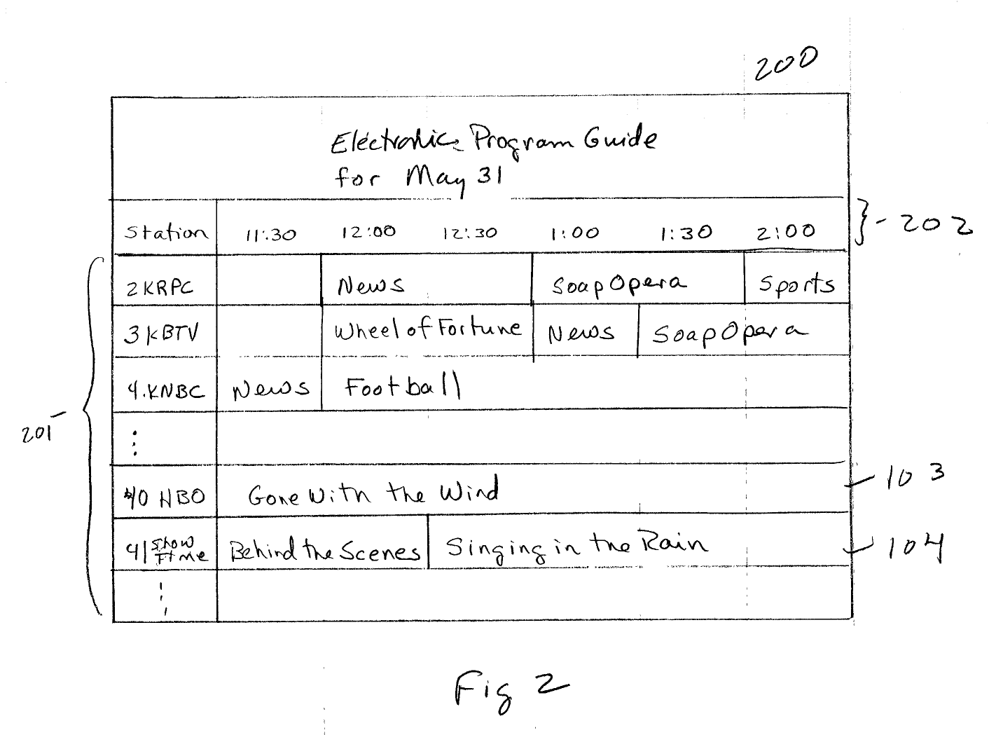

As discussed above, the system may allow a user to subscribe to a new service at the time the user selects to view that service. FIG. 2 illustrates an electronic program guide listing subscription services in one embodiment. The electronic program guide 200 includes channel identification information 201 and time slots 202. The rows 103 and 104 corresponding to channels 40 and 41 represent subscription services. In particular, row 103 represents the service HBO, which is currently transmitting the movie entitled “Gone with the Wind.” A user can select a channel by highlighting the channel using the arrow buttons on a remote control and then pressing the enter button, by directly entering the channel number on the numeric pad of the remote control, or by any other means for selecting a channel. When a channel for a subscription service is selected and the user is already subscribed to that service, then the system enables the transmitting of the content of that subscription service to the television for display. In contrast, if the user is not currently subscribed to that service, then the user is given the option to subscribe to that service. If the user decides to subscribe, then the system enables the transmitting of the content of that service to the television for display and records that the user has subscribed so that the enabling will occur automatically when the user selects the channel for that service in the future.

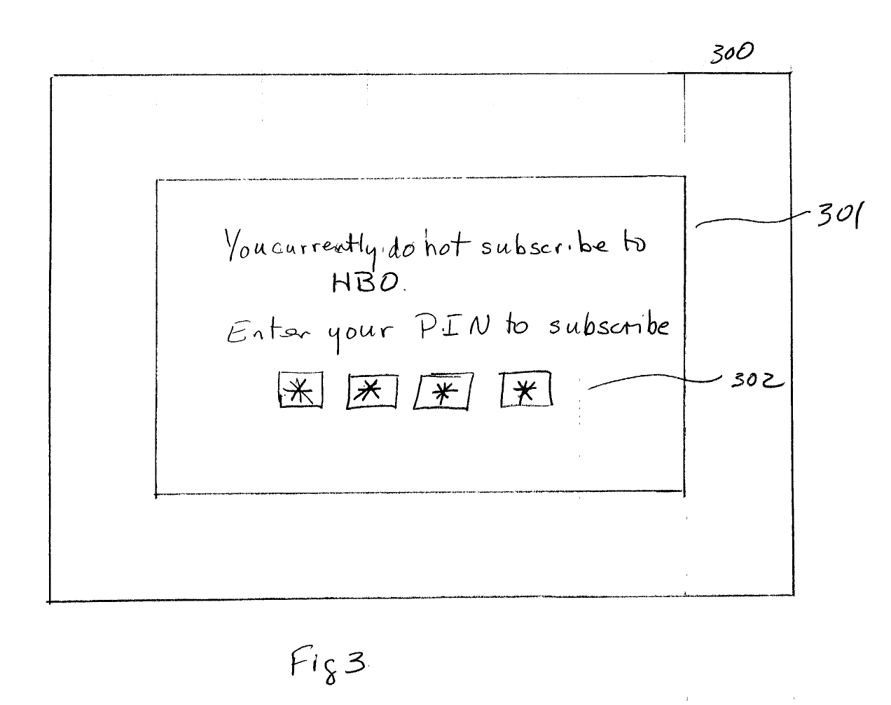

FIG. 3 is a diagram illustrating a display that allows a user to subscribe to a service in one embodiment. The display 300 includes a dialog box 301. The dialog box identifies to the user that the user is currently not subscribed to the service and requests the user to enter their personal identification number (“PIN”) 302 or other authentication information. To subscribe to the service, the user enters their PIN using, for example, the numeric pad of the remote control and presses the enter button on the remote control. One skilled in the art will appreciate that the entry of authentication information is optional and depends on the level of desired security. For example, the system may assume that anyone who has access to the set-top box is authorized to subscribe to the services and therefore would not prompt for authentication information. The set-top box forwards the information to the content server (or other server that provides administrative functions) which records the new subscription and enables the transmitting of the content for that subscription service to the user's television. When the user subsequently selects that service, the content of the subscription service is automatically transmitted to the user's television. Alternatively, rather than displaying the dialog box on a separate display, the system may display the dialog box within the row of the electronic program guide associated with the subscription service.

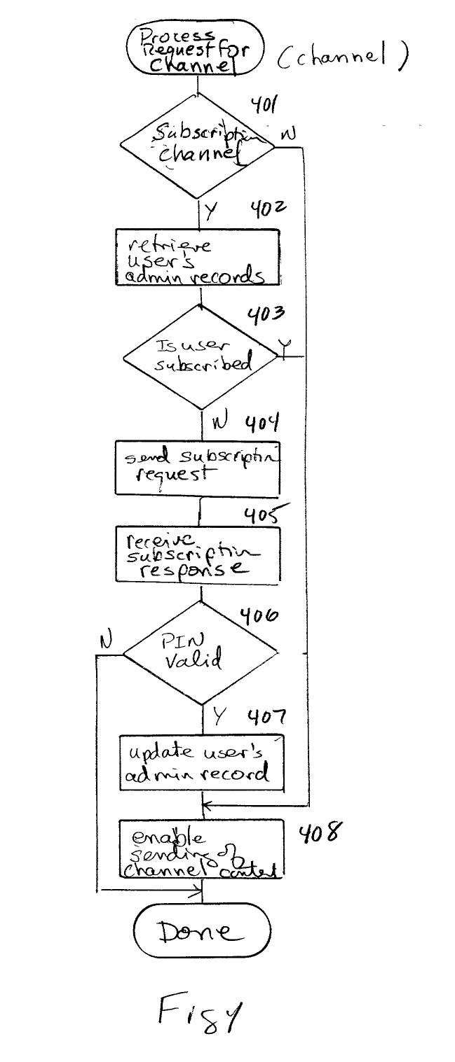

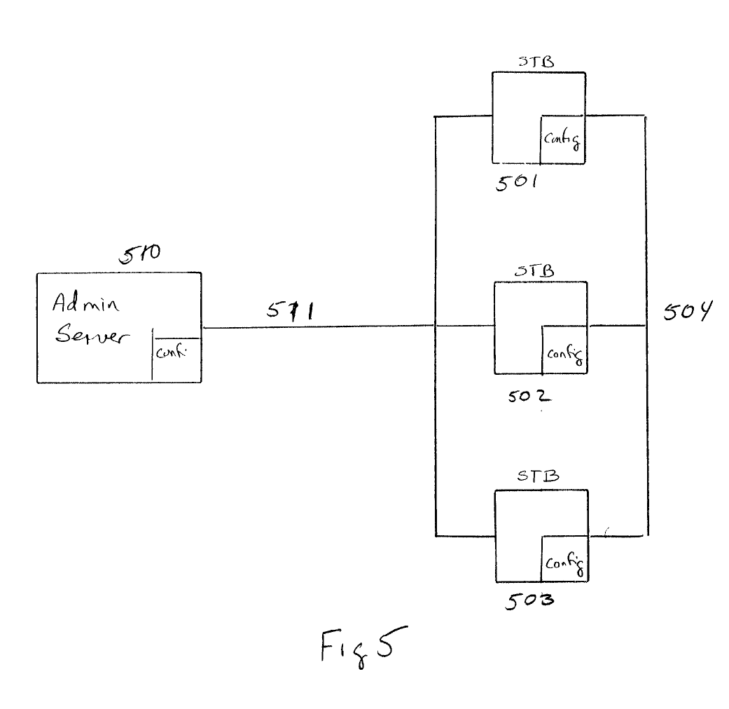

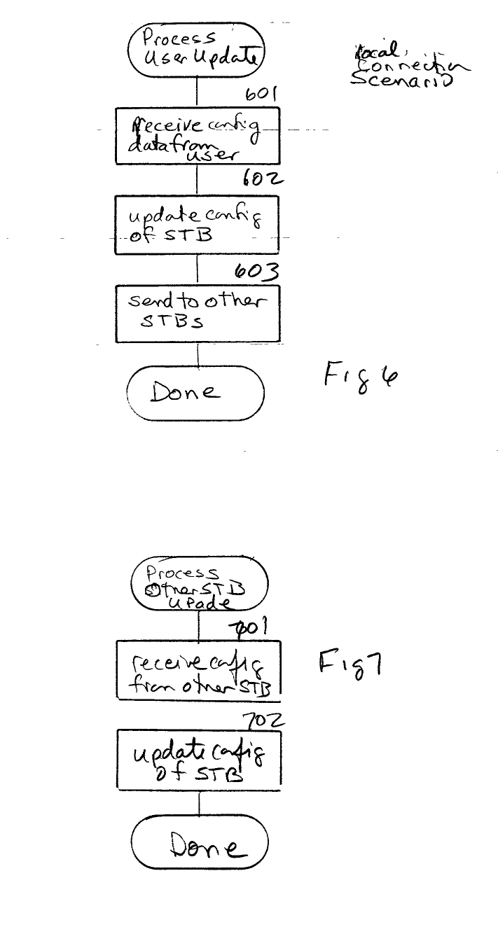

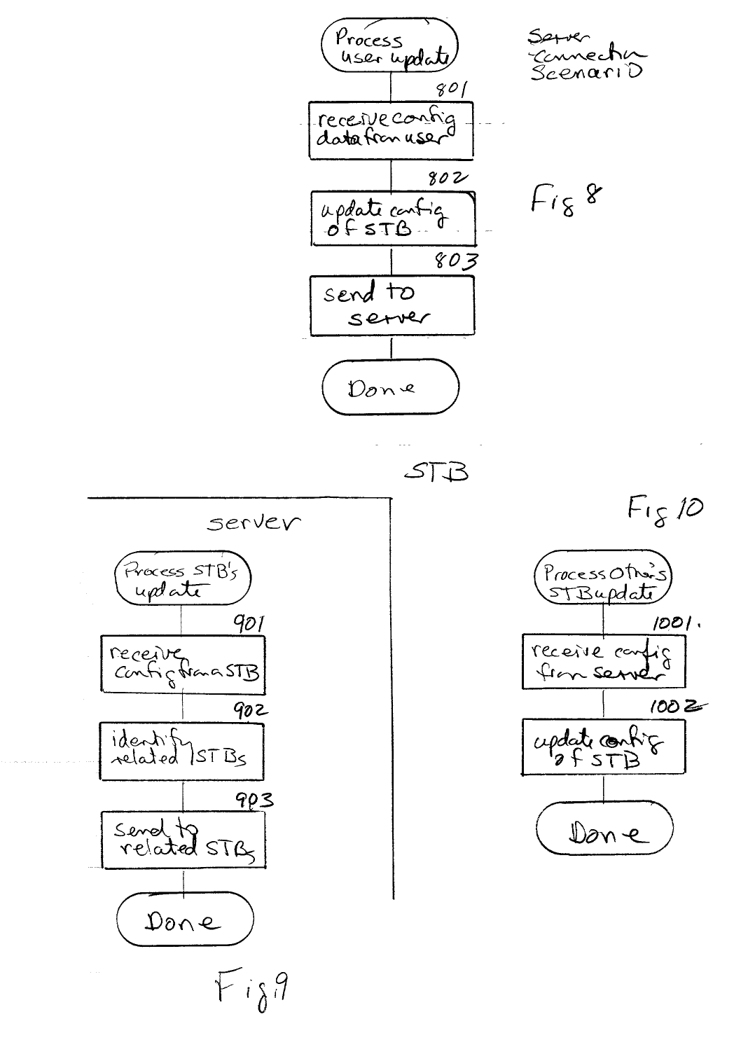

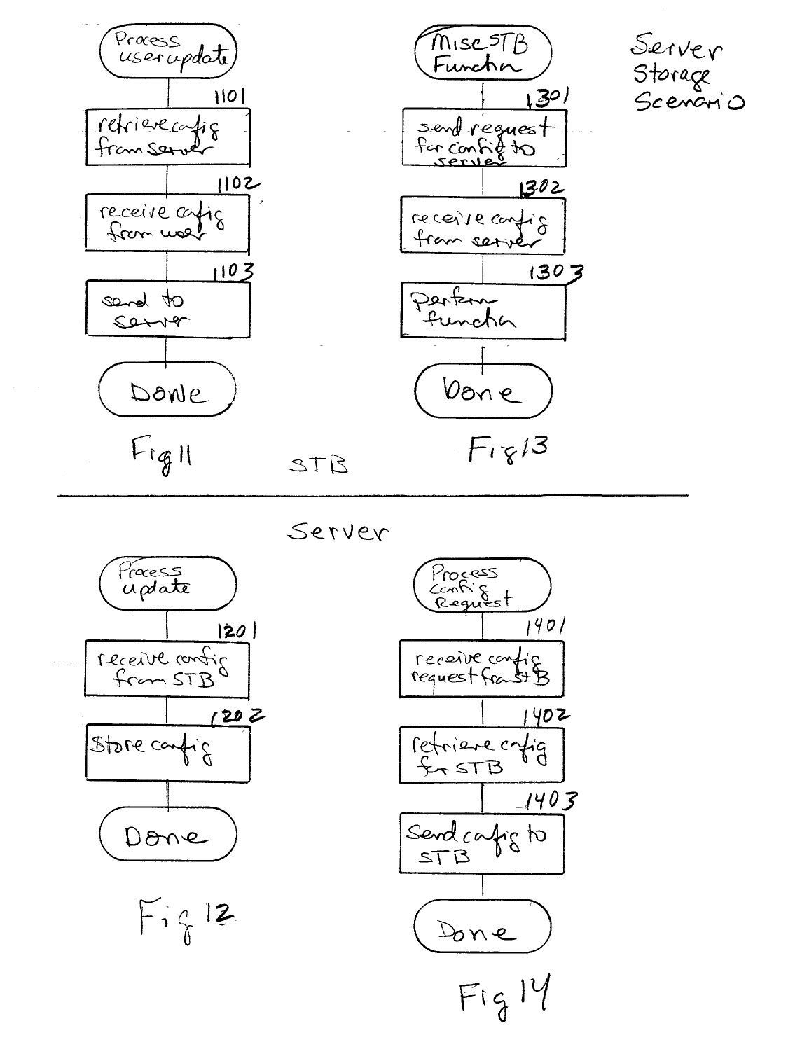

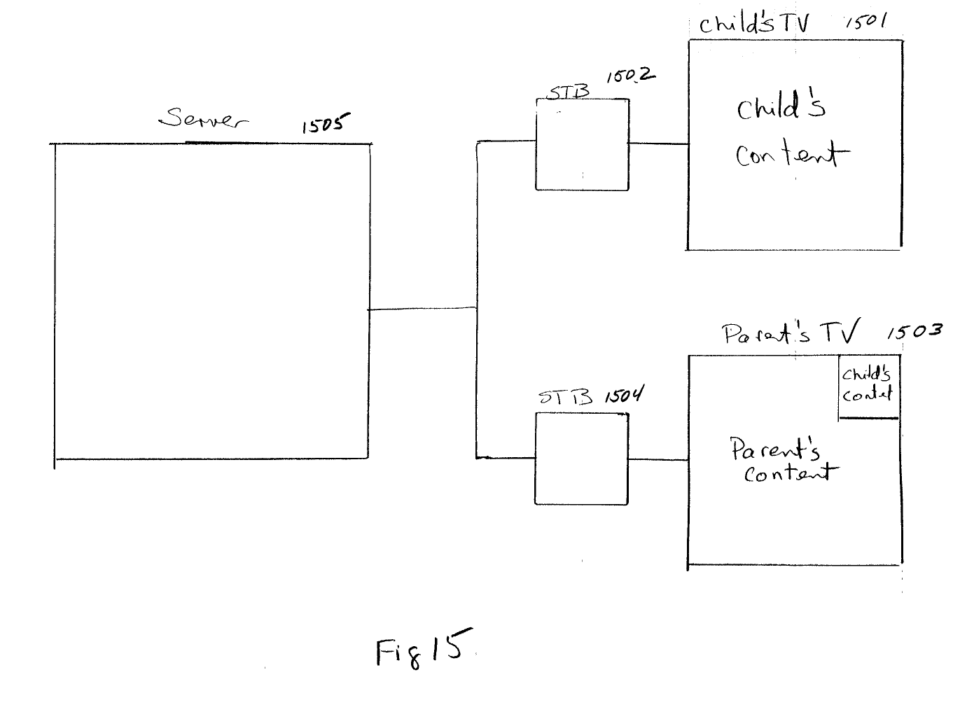

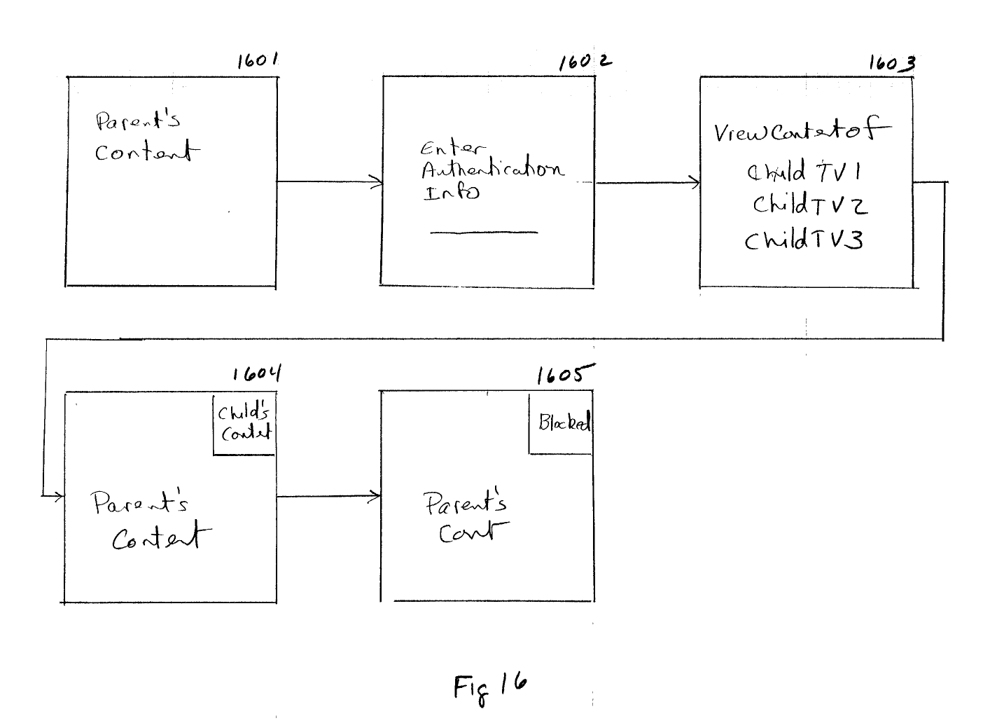

FIG. 4 is a flow diagram illustrating the processing of a request to subscribe to a subscription service in one embodiment. This processing is performed on a server that provides administrative services, such as tracking the services to which each user has subscribed. This processing is performed when a user selects to view a subscription service. In decision block 401, if the selected channel is a subscription channel (i.e., is assigned to a subscription service), then the component continues at block 402, else the component continues to block 408. In block 402, the component retrieves the administrative records for the user. The administrative records may be stored on a per-user, per-set-top box, or per-household basis. In decision block 403, if the user is currently subscribed to the selected channel, then the component continues at block 408, else the component continues at block 404. In block 404, the component sends a subscription request to the set-top box directing the set-top box to ask the user whether the user wants to subscribe to the selected subscription service and to provide authentication information. In block 405, the component receives the subscription response from the set-top box. In decision block 406, if the authentication information is valid, then the component continues at block 407, else the component completes. The component may also determine whether the user is authorized to subscribe to the service. For example, a child may provide their proper authentication information, but the child might not be authorized to subscribe to services. Before completing, the component may send a message to the set-top box indicating that the user could not be authenticated or is not authorized. In block 407, the component updates the user's administrative records to indicate the subscription to the service represented by the selected channel. In block 408, the component enables the transmitting of the content of the selected channel to the set-top box and then completes. One skilled in the art will appreciate that various processes of this component could be performed at the set-top box, such as the process of authenticating the user.

Replication of Configuration Information

As described above, configuration information entered at one set-top box may be automatically propagated to other set-top boxes. FIG. 5 is a block diagram illustrating various configurations of set-top boxes and administrative servers for replication of configuration information in one embodiment. The set-top boxes 501, 502, and 503 are connected to administrative server 510 via communications link 511. The communications link 511 may be a cable connection, a telephone-based connection, and so on. The set-top boxes may be interconnected via local area network 504. The set-top boxes 501, 502, and 503 have been designated to share common configuration information. When a user changes the configuration information at one of the set-top boxes, the system automatically replicates it to the other set-top boxes. The system can replicate the configuration information in various ways. First, the system may send the configuration information from one set-top box to the other set-top boxes via local area network 504 or some other local connection. For example, a user at set-top box 501 may change the filtering parameters of the set-top box. When the parameters have been changed, set-top box 501 then transmits the updated configuration information to set-top boxes 502 and 503 via the local area network. Upon receiving the updated configuration information, set-top boxes 502 and 503 update their configuration information. Second, the system may send the configuration information from one set-top box to the other set-top boxes via the administrative server. For example, a user at set-top box 501 may change the filtering parameters of the set-top box. When the parameters have been changed, set-top box 501 transmits the updated configuration information to the administrative server. Upon receiving the updated configuration information, the administrative server identifies the set-top boxes that are to share common configuration information and then transmits the updated configuration information via communications link 511 to set-top boxes 502 and 503. Upon receiving the configuration information, the set-top boxes 502 and 503 update their configuration information accordingly. Third, the system may store the configuration information only at administrative server 510. When a set-top box updates configuration information, it retrieves the configuration information on as-needed basis from the administrative server via communications link 511. When a user at set-top box 501 changes the filtering parameters of the set-top box, the set-top box 501 transmits the updated configuration information to the administrative server. When the administrative server receives the updated configuration information, it stores it locally. When set-top boxes 502 and 503 next request configuration information, the administrative server provides the updated configuration information to the requesting set-top boxes.

FIGS. 6-14 are flow diagrams illustrating various scenarios for replicating updated configuration information from a set-top box. FIGS. 6-7 are flow diagrams illustrating processing in a scenario in which the set-top boxes are connected via a local connection. FIG. 6 is a flow diagram illustrating the updating of configuration information when the set-top boxes are connected via a local connection in one embodiment. In block 601, the component receives updated configuration information from the user. The component may display the current values of the configuration information stored locally at the set-top box and request the user to enter the updated configuration information. In block 602, the component updates the configuration information stored at the set-top box. In block 603, the component sends the updated configuration information to the other set-top boxes via the local connection. The component may broadcast the updated configuration information over the local connection. Alternatively, the set-top box may know which other set-top boxes share the common configuration information and direct the updated configuration information to those set-top boxes. FIG. 7 is a flow diagram illustrating the processing of a set-top box that receives updated configuration information via a local connection in one embodiment. In block 701, the component receives the updated configuration information via the local connection. In block 702, the component updates the configuration information of the set-top box and then completes.

FIGS. 8-10 are flow diagrams illustrating processing in a scenario in which a set-top box replicates updated configuration information to the other set-top boxes via an administrative server. FIG. 8 is a flow diagram illustrating the processing of a set-top box that receives updated configuration information from a user and replicates it via an administrative server in one embodiment. In block 801, the component receives the updated configuration information from the user. In block 802, the component updates the configuration information of the set-top box. In block 803, the component sends the updated configuration information to the administrative server and then completes. FIG. 9 is a flow diagram illustrating the processing of an administrative server component that replicates updated configuration information in one embodiment. In block 901, the component receives the updated configuration information from a set-top box. In block 902, the component identifies the set-top boxes that share that configuration information. In block 903, the component sends the updated configuration information to the identified set-top boxes and then completes. FIG. 10 is a flow diagram illustrating the processing of a set-top box that receives updated configuration information from the administrative server in one embodiment. In block 1001, the component receives the updated configuration information from the administrative server. In block 1002, the component updates the configuration information of its set-top box and then completes.

FIGS. 11-14 are flow diagrams illustrating processing in a scenario in which the set-top boxes send updated configuration information to an administrative server for distribution to other set-top boxes on an as-needed basis. FIG. 11 is a flow diagram illustrating the processing of a set-top box that receives updated configuration information from a user and sends it to an administrative server for storage in one embodiment. In block 1101, the component retrieves the configuration information from the administrative server. In block 1102, the component receives updated configuration information from the user. In block 1103, the component sends the updated configuration information to the administrative server and then completes. FIG. 12 is a flow diagram illustrating the processing of an administrative server that receives updated configuration information and stores it locally in one embodiment. In block 1201, the component receives updated configuration information from a set-top box. In block 1202, the component stores the updated configuration information so that it can be retrieved on an as-needed basis by the set-top boxes. The component then completes. FIG. 13 is a flow diagram illustrating the processing of a miscellaneous component of a set-top box that retrieves configuration information from an administrative server on as-needed basis in one embodiment. In block 1301, the component requests the administrative server to provide configuration information. In block 1302, the component receives the configuration information from the administrative server. In block 1303, the component performs the miscellaneous processing that uses the received configuration information and then completes. FIG. 14 is a flow diagram illustrating the processing of the administrative server in response to a request for configuration information in one embodiment. In block 1401, the component receives a request for configuration information from a set-top box. In block 1402, the component retrieves the configuration information for the set-top box. The administrative server may maintain information that indicates which set-top boxes are to share common configuration information. In block 1403, the component sends the configuration information to the set-top box and then completes.

Real-Time Monitoring and Blocking of Content

As described above, the system allows one user to remotely monitor the content being viewed by another user and to optionally stop the transmitting of that content to the other user's television. In the case that the users are a parent and child, the system allows the parent to monitor the content being viewed by the child. The system allows the parent, from the parent's television, to view the content currently being transmitted to the child's television. The content being viewed by the child may be displayed in full-screen mode or as a picture-in-picture window on the parent's television. In either case, the parent can view the content that the child is currently viewing. The system allows the parent to optionally block the content from being transmitted to the child's television. When the system receives a request from the parent to block the content, the system notifies the administrative server to block the content currently being transmitted to the child's television. The administrative server may optionally request authentication information from the parent. The administrative server then records that the channel associated with the content currently being transmitted to the child's television is blocked from being transmitted to that television. The administrative server may direct the transmission of an indication that the channel is blocked or is temporarily unavailable when the child selects to display the content of that channel. Alternatively, depending on the processing power of the set-top boxes or gateway device at the parent's household, the monitoring and blocking may be handled locally without interaction with the administrative server.

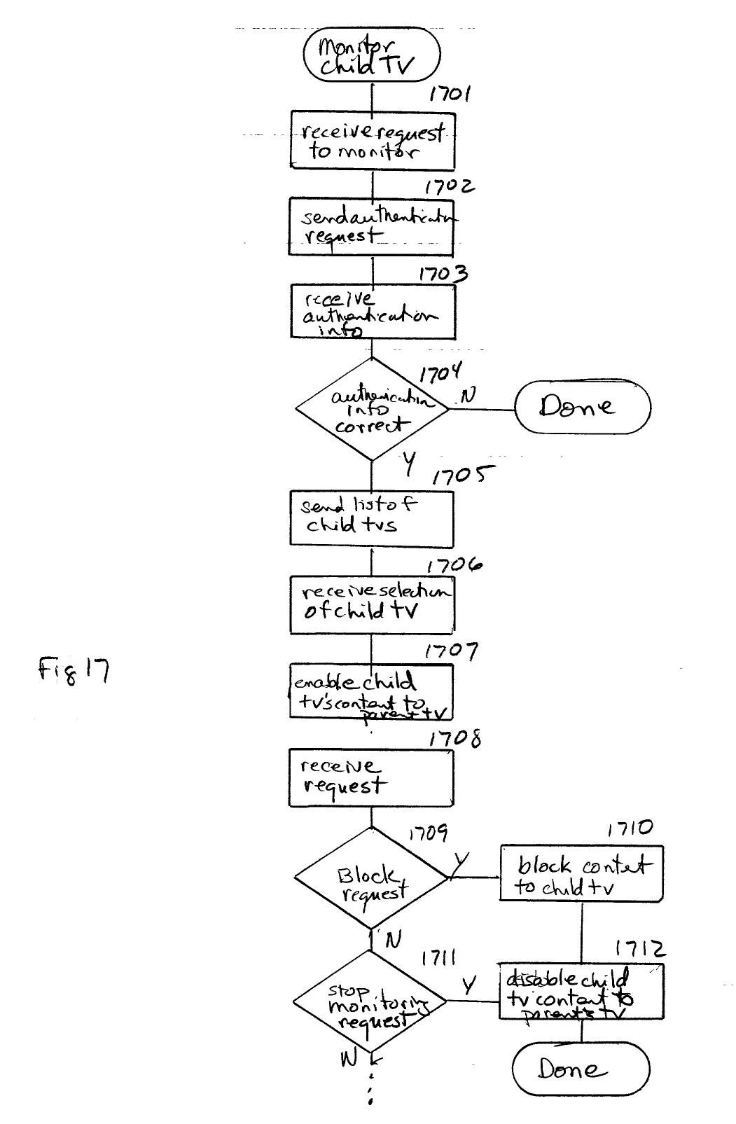

FIG. 15 is a block diagram illustrating the monitoring by a parent of content being viewed by a child in one embodiment. The child's television 1501 is connected to the child's set-top box 1502, and the parent's television 1503 is connected to the parent's set-top box 1504. The set-top boxes are connected to an administrative server 1505. A parent may interact with the parent's television and the parent's set-top box to display the contents of the child's television on the parent's television. In this example, the child's content is shown in the upper right corner of the parent's television. Depending on the type of content being transmitted, the monitoring may be controlled locally by the set-top boxes, or the set-top boxes may interact with the administrative server. For example, if the content of the child's television is a conventional television channel, then the parent's set-top box need only request the child's set-top box to provide the number of the channel being viewed by the child (assuming a local connection) and then tune into that channel. When the parent selects to block the content, the parent's set-top box may send a message to the child's set-top box to disable the display of that channel. Alternatively, if the content of the child's television is a multicast, Internet-based transmission, then the parent's set-top box may request, via the administrative server, to join the same multicast group that the child's set-top box has joined. When the parent selects to block the content, the set-top box requests the administrative server to effect the leaving of the child's set-top box from the multicast group.

FIG. 16 is a block diagram illustrating a user interface for monitoring and blocking of content in one embodiment. Initially, the parent's television displays conventional content as seen in display 1601. The parent then may use a remote control to direct the set-top box to enter a monitoring mode. The system may initially request authentication information from the parent as seen in display 1602. Upon entry of and verification of the authentication information, the system may display a list of the televisions that may be monitored by the parent as seen in display 1603. In this example, the parent can monitor the content of each of three televisions. When the parent selects a child's television, the content of the child's television is displayed in the upper-right corner of the parent's television as seen in display 1604. The parent can then select to block that content from being transmitted to the child's television. As seen in display 1605, the content of the child's television now indicates that the channel the child is currently viewing is blocked.

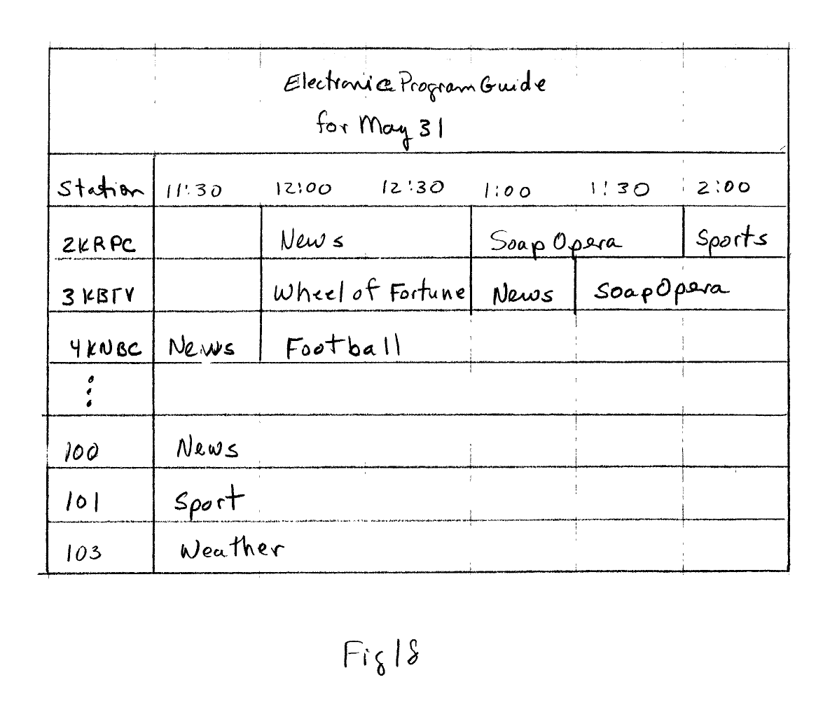

FIG. 17 is a flow diagram illustrating the processing of monitoring the content of a child's television in one embodiment. In this embodiment, the component executes on an administrative server that interacts with set-top boxes. Alternatively, this component may execute in a gateway computer in the parent's household. In block 1701, the component receives a request from a parent's set-top box to monitor a child's television. In block 1702, the component sends an authentication request to the parent's set-top box. In block 1703, the component receives the authentication information from the set-top box. In decision block 1704, if the authentication information is correct, then the component continues at block 1705, else the component completes. Before the component completes, it may send a notification to the parent's set-top box that the authentication information is incorrect. In block 1705, the component sends a list of the child televisions that can be monitored by the parent. The system may assume that all televisions in the same household may be monitored by any other television assuming a proper authentication and authorization, or the system may maintain a list of televisions that each television may monitor. In block 1706, the component receives a selection of a child's television. In block 1707, the component enables the transmitting of the content of the child's television to the parent's television. In block 1708, the component receives a request from the parent's set-top box. In decision block 1709, if the request indicates to block the content to the child's television, then the component continues at block 1710, else the component continues at block 1711. In block 1710, the component effects the blocking of the transmission of the content to the child's television. In decision block 1711, if the request indicates to stop monitoring the child's television, the component continues at block 1712, else the component continues to process any other requests. In block 1712, the component disables the transmitting to the parent's television of the content currently displayed at the child's television and then completes.

Web-Based Content Channel on Electronic Program Guide

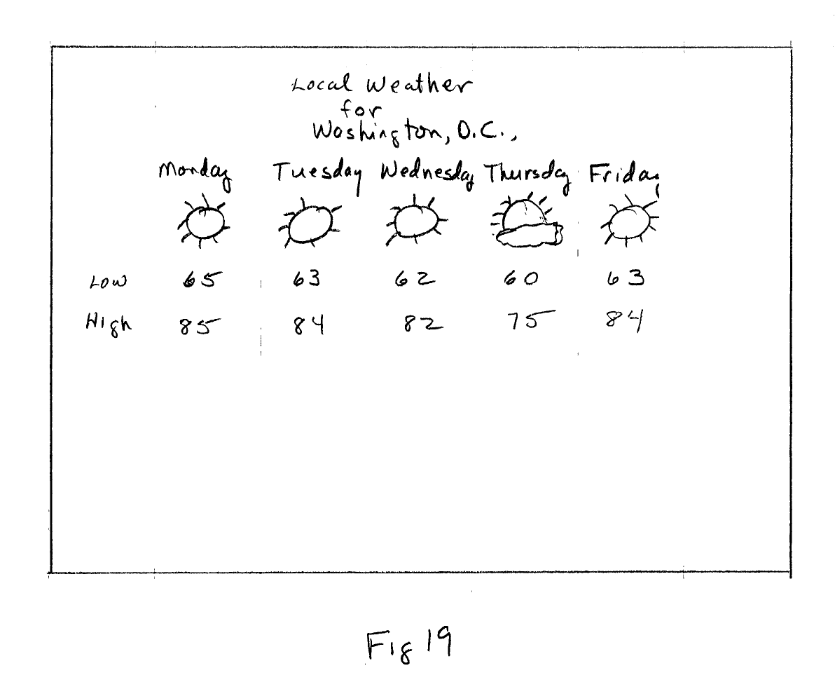

As described above, the system allows nontelevision programming content to be represented as a channel in an electronic program guide. In particular, the system assigns a different channel of an electronic program guide to each type of Internet-based content or on-demand programming content. When a user selects a channel representing nontelevision programming content, the system directs the content to be displayed on the user's television. FIG. 18 is a block diagram illustrating the display of an electronic program guide that displays Internet-based content as a channel in one embodiment. In this example, channels 2 through 99 are allocated to television programming content and channels 100 through 103 are allocated to web-based content. The user interacts with the electronic program guide in a conventional manner to select any of the channels for television programming content or nontelevision programming content. When a channel is selected, then the system effects the displaying of the content associated with that channel.

FIG. 19 is a block diagram illustrating the display of content associated with a nontelevision programming channel in one embodiment. In this example, the user selected channel 103 of FIG. 18 that is associated with web-based, weather content. The system may generate the web-based content by retrieving a web page via the Internet from a weather-related web site. The system may effect the displaying of the retrieved web page (optionally disabling the navigation controls of the web browser) or may extract content of interest from the web page and reformat it before displaying it on the television. Alternatively, the system may retrieve information via the Internet (e.g., weather, stock, and news) using other technologies such as the file transfer protocol (“FTP”).

From the above, it will be appreciated that various embodiments of the invention have been described for purposes of illustration. One skilled in the art will appreciate that modifications may be made without deviating from the spirit and scope of the invention. Accordingly, the invention is not limited except as by the appended claims.

1. A method for presenting an electronic program guide, the method comprising:
providing television programming information;
providing web site information; and
displaying an electronic program guide that includes the provided television information and the web site information.

2. The method of claim 1 wherein the displayed electronic program guide includes a row for each channel of the television programming information and a row for each web page of the web site information.

3. The method of claim 2 including when a row for a web page is selected, displaying information derived from the web page.

4. The method of claim 3 wherein the information derived from the web page excludes navigation features of the web page.

5. The method of claim 1 including when the web site information is selected, displaying information retrieved from a web site.

6. The method of claim 1 wherein web site information is displayed to approximate the display of a television channel.

7. A method of selecting Internet-based content to display, the Internet-based content being allocated a channel number not allocated to broadcast content, the method comprising:
displaying the broadcast content associated with a currently selected channel number;
receiving a selection of another channel number, the other channel number being allocated to the Internet-based content; and
in response to receiving the selection of the other channel number, displaying the Internet-based content associated with the selected channel number.

8. The method of claim 7 wherein the Internet-based content is derived from a web site.

9. The method of claim 7 wherein the Internet-based content is a web page.

10. The method of claim 7 wherein the selection of the other channel number is indicated by a next channel command.

11. The method of claim 7 wherein the selection of the other channel number is indicated by entry of the other channel number.

12. The method of claim 7 wherein the broadcast content is television content.

13. A method for presenting an electronic program guide, the method comprising:
providing television programming information;
providing nontelevision programming information; and
displaying an electronic program guide that includes a row for each channel of the provided television programming information and at least one row for the nontelevision programming information.

14. The method of claim 13 wherein the nontelevision programming information is Internet-based information.

15. The method of claim 14 wherein different types of Internet-based information are displayed as different rows.

16. The method of claim 13 wherein the nontelevision programming information is on-demand programming information.

17. The method of claim 16 wherein different types of on-demand programming information are displayed as different rows.

18. The method of claim 13 wherein the nontelevision programming information includes Internet-based information and on-demand programming information.

19. The method of claim 18 wherein each row represents a different channel number.

20. A system for presenting an electronic program guide, the comprising:
means for providing television and nontelevision programming information; and
means for displaying an electronic program guide that includes a row for at least one row for the nontelevision programming information.

21. The system of claim 20 wherein the nontelevision programming information is Internet-based information.

22. The system of claim 21 wherein different types of Internet-based information are displayed as different rows.

23. The system of claim 20 wherein the nontelevision programming information is on-demand programming information.

24. The system of claim 23 wherein different types of on-demand programming information are displayed as different rows.

25. The system of claim 20 wherein the nontelevision programming information includes Internet-based information and on-demand programming information.

26. The system of claim 25 wherein each row represents a different channel number.

27. The system of claim 20 wherein the electronic program guide includes row for television programming information.
